(19) United States
(12) Patent Application Publication
(10) Pub. No.: US 2007/0041391 A1
(43) Pub. Date: Feb. 22, 2007

(54) Method and apparatus for controlling imager output data rate

(75) Inventors: Sheng Lin, Sunnyvale, CA (US); Aman Jabbi, San Francisco, CA (US); Thomas Kopet, San Jose, CA (US); Clifford Yeung, San Jose, CA (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/206,149

(22) Filed: Aug. 18, 2005

(51) Int. Cl. H04L 12/56

(52) U.S. Cl. 370/412; 370/352

(57) ABSTRACT

A real-time application, such as e.g., an imager, that dynamically adjusts the output rate of an encoder and output rate of a buffer memory based on the fullness level of the buffer. Further, the slew rate of the clock and data signals input into output buffer drivers from the output buffer memory may be dynamically adjusted.

### FIELD OF THE INVENTION

The invention relates to a method and apparatus for controlling an imager's output data rate.

### BACKGROUND OF THE INVENTION

First-in, first-out (FIFO) memory is used in buffering data between devices that operate at different speeds, or in applications where data must be stored temporarily for further processing. Typically, this type of buffering is used to optimize bandwidth and to prevent data loss during high-speed communications. As the term FIFO implies, data is released from the buffer in the order of its arrival. Some FIFO memory devices read data using one clock and write data with another clock simultaneously. Flow control generates full and empty signals so that inputs do not overwrite the contents of the buffer. Depending on the device, FIFO memory can be unidirectional or bidirectional. FIFO memory can also include parallel inputs and outputs as well as programmable flags.

Typical image compression systems, when using a compression technique such as JPEG, input a frame or large set of real-time image data into an input buffer memory. Once a minimum required amount of the image data has been stored in the input buffer memory, it must be read-out of the memory so it can be compressed and encoded by an image compression engine and encoder logic, respectively. The process of producing JPEG images involves compression and encoding (hereinafter, this combination of processes may be referred to as any one of compression, encoding, or compression/encoding). After the image data has been encoded or compressed it is input into an output buffer memory (e.g., FIFO). However, it is possible that image data may continue to be input into the output buffer memory faster than image data is output from the output buffer memory. Accordingly, it is possible for the output buffer memory to overflow. This is undesirable since valid data would be lost. Moreover, to ensure smooth (i.e., less noisy) output of clock and data signals, it is also desirable to control the rising and falling slew rates of the output buffer drivers used to transmit these signals to the rest of the processing system.

Accordingly, there is a need and desire to dynamically adjust the rate of data being output from the output buffer memory to prevent overflow and adjust the output slew rates of data and clock signals during data output.

### BRIEF SUMMARY OF THE INVENTION

The invention provides a real-time application, such as e.g., an imager, that dynamically adjusts the output rate of an encoder and output rate of an output buffer memory based on the fullness level of the buffer memory. Further, the output slew rate of the data and clock signals, input into output buffer drivers from the output buffer memory and associated clock generation circuitry, may be dynamically adjusted.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a portion of a block diagram of an imaging system according to an exemplary embodiment of the invention;

FIG. 2 is a block diagram of a CMOS imager, which may be utilized in the imaging system illustrated in FIG. 1; and

FIG. 3 is a block diagram of a processing system utilizing the imaging system illustrated in FIG. 1.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural, logical and electrical changes may be made without departing from the spirit and scope of the present invention.

The present invention relates to data compression for a real-time application. Although the invention is described as being used in a real-time imager application, for the compression of real-time image data, it should be appreciated that the invention will apply to other data processing applications. In addition, the invention is described, for exemplary purposes only, as using JPEG forms of compression/encoding. It should be appreciated, however, that the novel aspects of the invention are not limited to the type of compression/encoding used on the data described herein.

As set forth above, one form of compression used in real-time applications such as e.g., imagers, is JPEG encoding. There are multiple forms of JPEG encoding that could be used to compress image data. JPEG encoding may also be used on color image data. In JPEG encoding the data to be compressed/encoded is grouped into multiple minimum coded units (MCUs). MCUs are used to break down the image into workable blocks of data for the encoding process. The manner in which the data is grouped in the MCUs depends on the type of compression/encoding scheme being implemented and is not limiting to this invention. For example, one known JPEG compression color format is the YCbCr 4:2:2 format. The YCbCr 4:2:2 format requires 8 lines of pixel data for luminance component Y and 8 lines of pixel data for chrominance components Cb and Cr to re-order the image pixels into MCUs. Other known JPEG encoding formats that could be used with the invention include, for example, YCbCr 4:4:4, YCbCr 4:2:0 and monochrome formats.

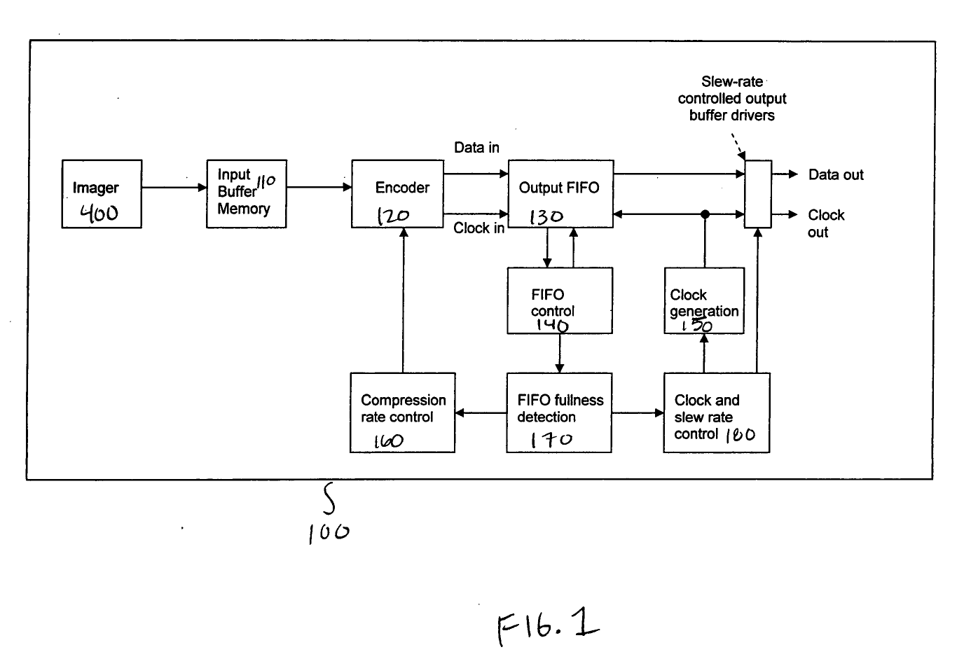

FIG. 1 is a block diagram of an imaging system 100 according to an exemplary embodiment of the invention. The system 100 includes an imager 400, an input buffer memory 110, an encoder 120, an output buffer memory (FIFO) 130, a set of output buffer drivers 190, an output buffer memory (FIFO) control unit 140, a fullness detection unit 170, a compression rate control unit 160, a clock and slew rate control unit 180, and a clock generation unit 150. The encoder 120, according to an embodiment of the invention, is a JPEG encoder designed to implement the required encoding/compression of image data from the imager 400. The imager 400 may be a CMOS imager, CCD imager, or other real-time imaging device. The output buffer 130 may be FIFO memory. The input buffer memory 110 maybe a reorder buffer such as the buffer described in U.S. application Ser. No. 11/195,689, for example, herein incorporated by reference.

The output of the imager 400 is written into at least one buffer memory 110 prior to being read-out and compressed/encoded by the encoder 120. The encoder 120 processes the image data as it is output from the buffer memory 110 under the control of the compression rate control unit 160. The output buffer memory (FIFO) 130 receives the data processed by the encoder 120. The output buffer memory (FIFO) 130 functions to store and output encoded image data to the output buffer drivers 190. The FIFO control unit 140 and the FIFO fullness detection unit 170 determine the “watermark” (i.e., percentage of the buffer that is full) of the output buffer memory (e.g., FIFO) 130. The compression rate control unit 160 receives the watermark and accordingly adjusts the output rate of the encoder 120, if necessary. The clock and slew rate control unit 180 uses the watermark to determine the frequency of the clock generated by the clock generation unit 150 and adjusts the slew rate (i.e., rise and fall times) of the output buffer drivers 190 which receive both the clock signal generated by clock generation unit 150 and the data signals from the output buffer memory 130. The clock signal generated by the clock generation unit 150 is also input to the output buffer memory 130 for the purpose of reading the output buffer memory's contents.

The clock and slew rate control unit 180 and the compression rate control unit 160 will switch the output clock frequency and adjust the slew rate of the clock and data signals, if necessary, based on the watermark of the output buffer memory 130. When the output buffer memory watermark reaches 50 percent full, the clock and slew rate control unit 180 typically increases the frequency of the output clock signal and increases the slew rate of the output buffer drivers 190. This increase in the output clock signal frequency will unload the output buffer memory 130 at a faster rate. However, depending on the image complexity and quantization table settings, the compressed image data may still be generated by the encoder 120 faster than the output buffer memory 130 can be unloaded. Should the output buffer memory watermark equal 75 percent or higher, the output clock signal frequency is typically increased further by an appropriate corresponding amount. When the output buffer memory watermark drops back to 50 percent, the frequency of the output clock signal is typically reduced by an appropriate corresponding amount. When the output buffer memory watermark drops to 25 percent, the output clock signal frequency is typically further reduced by an appropriate corresponding amount. At each watermark interval that causes the frequency of the output clock signal to be adjusted, the slew rate of the output buffer drivers 190 is also appropriately adjusted. The percentages described herein are only exemplary and may be tailored according to the implementation.

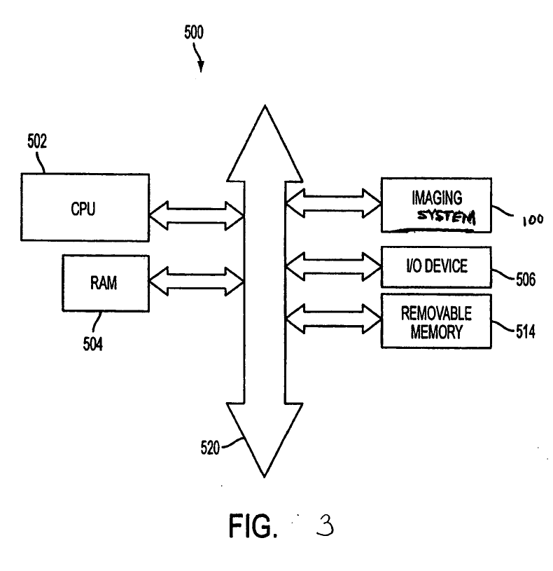

In one exemplary embodiment of the invention, CPU unit 502, illustrated in FIG. 3, can program three master clock divisors and three slew rate settings in the clock and slew rate control unit 180 for use in generating the output clock signal by the clock generation unit 150 and setting the slew rate in the output buffer drivers 190. In this embodiment, clock generation unit 150 generates the output clock from another master clock by reducing the frequency of the master clock by a factor determined by one of the master clock divisors. The first master clock divisor and the first slew rate setting are used when output buffer memory 130 is less than 50% full. When output buffer memory 130 reaches 50% and 75% full, the clock generation unit 150 and the output slew rate are switched to the second and third master clock divisors and the second and third slew rate settings, respectively. When the output buffer memory 130 fullness level drops to 50% and 25% full, the output clock generation unit 150 and the slew rate are switched back to the second and first master clock divisors and the second and first slew rate settings, respectively. It should be noted that the number of master clock divisors, the slew rate settings, and the output buffer memory fullness levels used in this embodiment are only exemplary and may be tailored according to the implementation.

When overflow of the output buffer memory 130 occurs, an additional set of preloaded quantization tables may be utilized by the encoder 120 to encode the next image frame sent to the output buffer memory 130. The frequency of the output clock signal is set to a nominal level at the beginning of the subsequent frame.

In one embodiment of the invention, CPU unit 502 can program three different sets of quantization tables and quantization scale factors for use by the encoder 120 during compression of image frames. The compression rate control 160 scales the values in each set of quantization tables using the latter's quantization scale factors prior to using the tables to compress an image frame. In this embodiment, an image frame is initially encoded using the first set of quantization tables and the corresponding scale factors. If this encoding results in overflow of output buffer memory 130, the image frame is optionally captured again and then encoded using the second set of quantization tables and the corresponding scale factors. If this encoding results in overflow a second time, the image frame is optionally captured again and then encoded using the third set of quantization tables and the corresponding scale factors. If encoding results in overflow yet a third time, the latter encoding sequence repeats starting with the first set of quantization tables and the corresponding scale factors. Before the sequence repeats, it is expected that the CPU 502 will have had an adequate opportunity to reprogram one or more quantization scale factors and/or quantization tables so as to prevent further overflows. It is typically faster for the CPU 502 to reprogram single scale factors rather than sets of quantization tables, since the tables typically consist of many values. It should be noted that the number of quantization tables and scale factors used in this embodiment are only exemplary and may be tailored according to the implementation.

The dynamic adjustment of the output rate of the encoder 120 and output buffer memory 130 based on the fullness level of the output buffer memory 130 helps prevent overflow of the output buffer memory 130. Further, the output slew rate of the clock and data signals input into the output buffer drivers 190 may be dynamically adjusted to smooth the output of data.

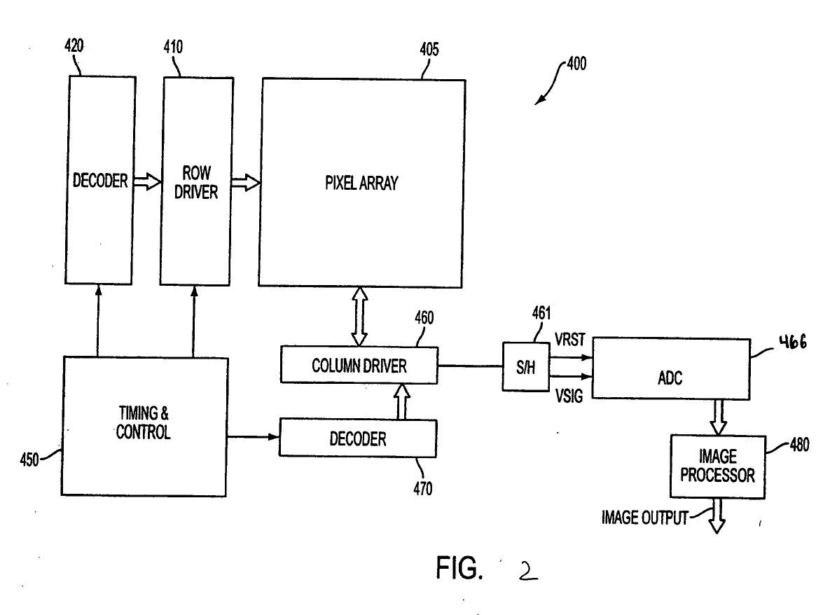

FIG. 2 illustrates an exemplary imager 400 that may be used in the imaging system 100 of FIG. 1. The imager 400 has a pixel array 405. Row lines are selectively activated by a row driver 410 in response to row address decoder 420. A column driver 460 and column address decoder 470 are also included in the imager 400. The imager 400 is operated by the timing and control circuit 450, which controls the address decoders 420, 470. The control circuit 450 also controls the row and column driver circuitry 410, 460.

A sample and hold circuit 461 associated with the column driver 460 reads a pixel reset signal Vrst and a pixel image signal Vsig for selected pixels. An analog-to-digital converter 466 (ADC) outputs a digital code corresponding to the difference between the Vrst and Vsig signals. The analog-to-digital converter 466 supplies the digitized pixel signals to an image processor 480, which forms and outputs a digital image. The output digital image data is subsequently input into the buffer memory 110 (FIG. 1) where it is stored and encoded as described above with reference to FIG. 1.

FIG. 3 shows a system 500, a typical processor system modified to include an imaging system 100 (FIG. 1) of the invention. The processor system 500 is exemplary of a system having digital circuits that could include imager devices and image compression devices (e.g., a JPEG encoder). Without being limiting, such a system could include a computer system, camera system, scanner, machine vision, vehicle navigation, video phone, surveillance system, auto focus system, star tracker system, motion detection system, image stabilization system, and data imaging systems.

System 500, for example a camera system, generally comprises a central processing unit (CPU) 502, such as a microprocessor, that communicates with an input/output (I/O) device 506 over a bus 520. Imaging system 100 also communicates with the CPU 502 over the bus 520. The processor-based system 500 also includes random access memory (RAM) 504, and can include removable memory 514, such as flash memory, which also communicate with the CPU 502 over the bus 520. The imaging system 100 may be combined with a processor, such as a CPU, digital signal processor, or microprocessor, with or without memory storage on a single integrated circuit or on a different chip than the processor.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. A method of processing real-time data, said method comprising the acts of:
encoding data by an encoder;
outputting from said encoder the encoded data;
storing the encoded data into an output buffer memory;
determining the fullness condition of said output buffer memory; and
adjusting a first control signal applied to said encoder and a second control signal applied to said output buffer memory based on said fullness condition of said output buffer memory.

2. The method of claim 1, wherein said act of storing the encoded data begins as a portion of the first data is being encoded by the encoder.

3. The method of claim 1, further comprising the act of reading out said encoded data stored in said output buffer memory into output buffer drivers.

4. The method of claim 3, wherein said adjusting step further comprises adjusting a slew rate of the output buffer drivers.

5. The method of claim 3, further comprising the act of reading out said encoded data from said output buffer drivers.

6. The method of claim 1, wherein said second control signal is a clock signal.

7. The method of claim 1, further comprising controlling the rate of data output from the encoder based on said fullness condition of said output buffer memory.

8. The method of claim 1, wherein a predetermined fullness condition level triggers corresponding control signal levels in said first and second control signals.

9. The method of claim 1, further comprising adjusting encoding characteristics based on said fullness condition of said output buffer memory.

10. The method of claim 1, wherein said encoding is JPEG encoding.

11. The method of claim 1, wherein said encoder performs image compression.

12. The method of claim 1, wherein said encoder performs data compression.

13. A system for processing real-time data, said system comprising:
an encoder for encoding data;
an output buffer memory for storing data encoded by said encoder;
a detection unit configured to detect a fullness condition of said output buffer memory; and
a control unit for adjusting a clock signal of said output buffer memory based on said fullness condition.

14. The system of claim 13, wherein said output buffer memory is a FIFO buffer memory.

15. The system of claim 13, further comprising a second control unit for controlling said encoder.

16. The system of claim 15, wherein said second control unit assists in controlling the data output rate of said encoder.

17. The system of claim 13, further comprising output buffer drivers configured to receive data from said output buffer memory.

18. The system of claim 17, wherein a slew rate of said output buffer drivers is controlled based on said fullness condition detected in the output buffer memory.

19. The system of claim 13, wherein said encoder is a JPEG encoder.

20. The system of claim 13, wherein said processing system provides data compression.

21. The system of claim 13, wherein said processing system provides image compression.

22. The system of claim 13, wherein coding characteristics of said encoder are adjusted based on said fullness condition.

23. A processor system comprising:
a processor; and
an imaging device connected to said processor, said imaging device comprising:
an imager, said imager outputting image data, an encoder, said encoder encoding image data output from said imager;
an encoder for encoding data;
an output buffer memory for storing data encoded by said encoder;
a detection unit configured to detect a fullness condition of said output buffer memory; and
a control unit for adjusting a clock signal of said output buffer memory based on said fullness level.

24. The system of claim 23, wherein said output buffer memory is a FIFO buffer memory.

25. The system of claim 23, further comprising a second control unit for controlling said encoder.

26. The system of claim 25, wherein said second control unit assists in controlling the data output rate of said encoder.

27. The system of claim 23, further comprising output buffer drivers configured to receive data from said output buffer memory.

28. The system of claim 27, wherein a slew rate of said output buffer drivers is controlled based on said level of fullness detected in the output buffer memory.

29. The system of claim 23, wherein said output buffer memory is FIFO memory.

30. The system of claim 23, wherein coding characteristics of said encoder are adjusted based on said fullness condition.

31. A method of image compression and processing comprising:
collecting raw image data;
compressing said raw image data by an encoder;
outputting from said encoder the compressed image data;
storing the encoded image data into an output buffer memory;
determining the fullness condition of said output buffer memory; and
adjusting a first control signal applied to said encoder and a second control signal applied to said output buffer memory based on said fullness condition of said output buffer memory.

32. The method of claim 31, wherein said act of storing the compressed image data begins as a portion of the image data is being compressed by the encoder.

33. The method of claim 31, further comprising the act of reading out said compressed image data stored in said output buffer memory into output buffer drivers.

34. The method of claim 31, wherein said adjusting step further comprises adjusting a slew rate of the output buffer drivers.

35. The method of claim 34, further comprising the act of reading out said compressed image data from said output buffer drivers.

36. The method of claim 31, wherein said control signal is a clock signal.

37. The method of claim 31, further comprising controlling the rate of compressed image data output from the encoder based on the determined fullness condition of said output buffer memory.

38. The method of claim 31, wherein a predetermined fullness condition level triggers corresponding control signal levels in said first and second control signals.

39. The method of claim 31, further comprising adjusting encoding characteristics based on the determined fullness condition of said output buffer memory.
